(19) United States
(12) Patent Application Publication
(10) Pub. No.: US 2017/0356497 A1
(43) Pub. Date: Dec. 14, 2017

(54) BEARING RACE

(71) Applicant: Caterpillar Inc., Peoria, IL (US)

(72) Inventors: Ryan Lozier, Peoria, IL (US); James R. Carlberg, Peoria, IL (US)

(73) Assignee: Caterpillar Inc., Peoria, IL (US)

(21) Appl. No.: 15/180,189

(22) Filed: Jun. 13, 2016

(51) Int. Cl. F16C 33/66; F16C 33/58

(52) U.S. Cl. CPC F16C 33/6648; F16C 33/583

(57) ABSTRACT

Disclosed is a bearing race comprising a surface having a plurality of pores formed therein. A lubricant is provided in the pores. The race has a body having a porous volume contiguous with the surface. The surface includes a load bearing zone configured to be in contact with a rolling element of a bearing, the pores being distributed on the surface to provide the lubricant to the load bearing zone.

### TECHNICAL FIELD

The present disclosure relates to parts for bearings. More particularly, the present disclosure relates to a bearing race.

### BACKGROUND

The use of bearings as friction reducing devices is well known in the art. For example, to render a shaft rotatable with respect to a stationary housing of a motor, a bearing may be provided between the shaft and the housing of the motor.

Lubricants may typically be provided to facilitate operation of the bearing, for example by introducing lubricant to the rolling elements and races of a bearing when assembling, or packing, the bearing. Lubricants deteriorate with use leading to wear on the bearing races unless the lubricant is replaced periodically.

PCT publication WO2015/091728 discloses a rolling element for a bearing that is at least partially constituted of a first material being printed via an additive manufacturing process to define at least one channel open to an outer surface of the rolling element. The channel is configured to transport, in use, a lubricant from a hollow structure within the rolling element to the outer surface. Distribution of lubricant from such rolling elements may sometimes be non-uniform along a bearing race during use, leading to the possibility of wear in portions of the bearing race where little lubricant is present. Hence, there is a need for a bearing which addresses, or at least partially ameliorates, these challenges with bearing lubrication.

### SUMMARY OF THE DISCLOSURE

In an aspect of the present disclosure, a bearing race comprises a surface having a plurality of pores formed therein, a lubricant being provided in the pores.

In another aspect of the present disclosure, a method of manufacturing a bearing race comprises producing the bearing race using at least an additive manufacturing process, the bearing race including a surface having a plurality of pores formed therein. The method further comprises providing a lubricant within the pores.

Other features and aspects of this disclosure will be apparent from the following description and the accompanying drawings.

### BRIEF DESCRIPTION OF THE DRAWINGS

FIG. 1 is a cutaway perspective view of an exemplary bearing with inner and outer races, in accordance with an embodiment of the present disclosure;

FIGS. 2-8 are enlarged perspective views of cutaway sections of a bearing race, in accordance with various embodiments of the present disclosure; and

FIG. 9 is a flow chart depicting a method of manufacturing a bearing race, in accordance with an embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

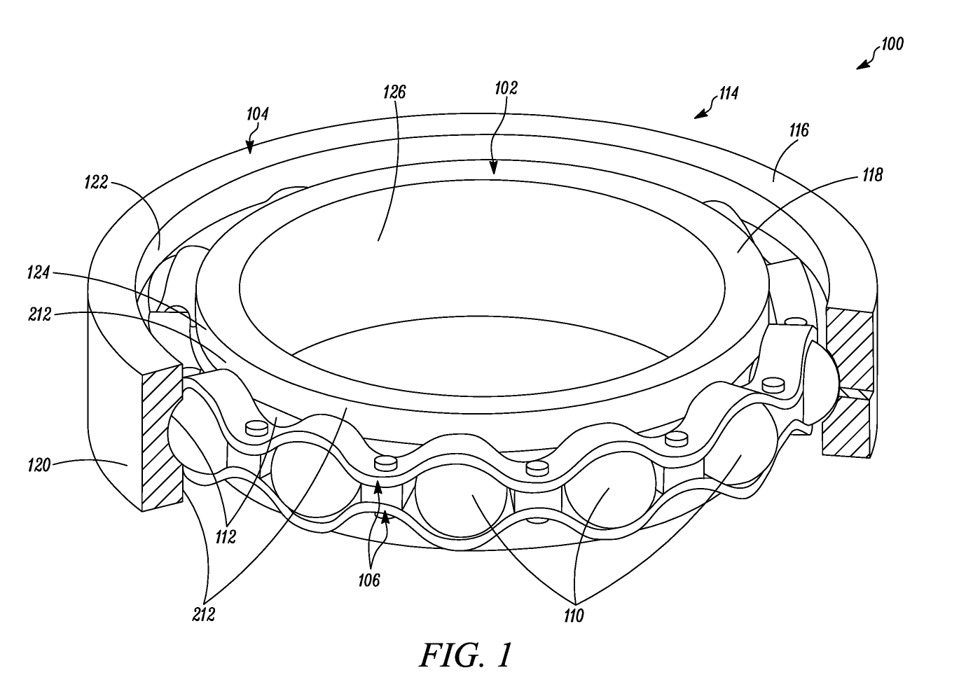

The present disclosure relates to a bearing race having a surface thereof provided with a plurality of pores in which lubricant is provided. FIG. 1 shows an exemplary bearing 100 in which embodiments of the present disclosure may be implemented. As shown, the bearing 100 includes an inner bearing race 102, an outer bearing race 104. The bearing races 102, 104 each have an inner surface 124, 122 and an outer surface 126, 120, respectively. The bearing 100 also includes a plurality of rolling elements 110 rotatably supported between the inner surfaces 124, 122 of the bearing races 102, 104. Each rolling element 110 is spaced apart from adjacent rolling elements 110 by a bearing cage 106.

The inner surfaces 124, 122 of the bearing races 102, 104 each have a load bearing zone 112 which contact the rolling elements 110. The inner surfaces 124, 122 of the bearing races 102, 104 each have a plurality of pores (not shown in FIG. 1) formed therein. A lubricant (not shown in FIG. 1) is provided in the pores to lubricate the bearing races 102, 104.

In the illustrated example of FIG. 1, each rolling element 110 is embodied in the form of a spherical ball that is rotatably disposed between the inner bearing race 102 and the outer bearing race 104. Although the rolling elements 110 are being depicted as spherical balls in the example of FIG. 1, the term “rolling element” is not limited to the spherical balls disclosed herein. Where the bearing is of a type other than the spherical ball bearing type shown in FIG. 1, various other types of rolling elements including, but not limited to, cylindrical rollers, needle rollers, gearwheel rollers, and the like may be used in lieu of the spherical balls to form the rolling elements 110 for that type of bearing. In any case, it will be appreciated that regardless of the type of rolling elements used, embodiments disclosed herein can be similarly applied to various other types of bearings known in the art without deviating from the spirit of the present disclosure.

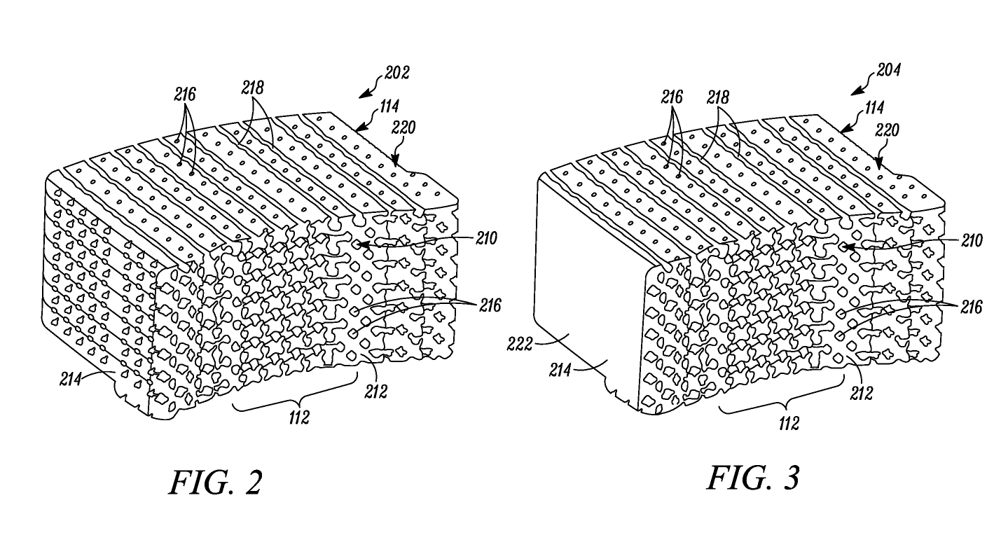

Various configurations of inner and outer bearing races are possible without departing from the spirit of the present disclosure. Exemplary embodiments are described below with reference to FIG. 2 to FIG. 8. Each of these embodiments are described with reference to cutaway sections of a bearing race, and it will be appreciated that the section may be from the inner race 102 and/or the outer race 104 of FIG. 1.

Referring to FIG. 2, a cutaway section 202 of a bearing race 114 is depicted in accordance with an embodiment of this disclosure. As shown in FIG. 2, the bearing race 114 has a porous surface 212 having a plurality of pores 216 formed therein. The porous surface 212 is disposed towards the rolling elements 110 of the bearing 100 (refer to FIG. 1). The porous surface 212 includes a load bearing zone 112 e.g., the load bearing zone 112 of the inner bearing race 102 or the load bearing zone 112 of the outer bearing race 104 with which the rolling elements 110 are disposed in contact. The contact established between the load bearing zone 112 and each of the rolling elements 110 is inclusive of either or both of rolling and sliding contact. A lubricant (not shown) is provided in the pores 216. This provides lubrication to at least the load bearing zone 112, where contact between the bearing race 114 and rolling elements 110 occurs.

As shown in the illustrated embodiment of FIG. 2, the pores 216 disposed on the porous surface 212 are configured to provide lubricant to the load bearing zone 112 of the bearing race 114. Each of the pores 216 on the surface 212 may extend into a body 220 of the bearing race 114 as pathways 218. The pathways 218 may form a porous volume 210 of the body 220. In one embodiment, the pathways 218 are configured to fluidly communicate the lubricant to the pores 216, for instance via capillary action. In an alternative embodiment, lubricant in the pathways 218 lubricates the bearing race 114 the porous surface 212 wears through use to expose the pathways 218 and lubricant provided therein.

In embodiments herein, the pores 216 could be located on any portion of an outer surface 214 of the bearing race 114. In one embodiment, the porous volume 210 comprises substantially all of the body 220. For example, as shown in FIG. 2, the pores 216 are configured on all surfaces of the body 220 i.e., outer or side surfaces 214 in addition to the porous surface 212. As the pores 216 are configured on the outer surface 214 in addition to the porous surface 212 in the illustrated example of FIG. 2, the pores 216 may act as a means to fluidly communicate lubricant between the porous surface 212 and a remainder of the outer surface 214 associated with the body 220.

In an embodiment, the bearing race 114 of FIG. 2 may be embodied as the outer bearing race 104 of the bearing 100 shown in FIG. 1. In this embodiment, the porous surface 212 may be located on an inner surface 122 of the outer bearing race 104 (refer to FIG. 1) that is disposed facing the rolling elements 110. As the load bearing zone 112 is also located on the inner surface 122 of the outer bearing race 104, the pores 216 on the porous surface 212 may deliver lubricant to the load bearing zone 112 of the outer bearing race 104 and lubricate a movement of the rolling elements 110 thereon.

In another embodiment, the bearing race 114 of FIG. 2 may be embodied as the inner bearing race 102 of the bearing 100 shown in FIG. 1. In this embodiment, the porous surface 212 may be located on an inner surface 124 of the inner bearing race 102 (refer to FIG. 1) which would be disposed facing the rolling elements 110. As the load bearing zone 112 would be located on the inner surface 124 of the inner bearing race 102, the pores 216 on the porous surface 212 may be configured to deliver lubricant to the load bearing zone 112 of the inner bearing race 102 and lubricate a movement of the rolling elements 110 thereon. Although the load bearing zones 112 of the inner and outer races 102, 104 associated with the exemplary bearing 100 of FIG. 1 are configured to act as radial load bearing zones, in other types of bearings, the load bearing zone 112 may be configured to act as an axial load bearing zone or a load bearing zone that is capable of handling both axial and radial loads, each of which may be incident on the rolling elements 110 of the bearing 100.

With regards to the illustrated embodiment of FIG. 2, the cutaway section 202 of the bearing race 114 may be regarded as being representative of at least one of the inner bearing race 102 and the outer bearing race 104. In an example, the outer bearing race 104 alone may be provided with a porous surface. In another example, the inner bearing race 102 alone may be provided with a porous surface. In yet another example, both the inner and outer races 102, 104 of the bearing 100 may each be provided with a porous surface.

In embodiments of this disclosure, the pores 216 of the bearing race 114 may be filled or impregnated with a predetermined amount of lubricant. For example, lubricant may be injected or pressed into the pores 216 of the bearing race 114 so that the pathways 218 are filled with a predetermined amount of lubricant. In another example, the bearing race 114 may be soaked in the lubricant such that the pores 216 are filled with the predetermined amount of lubricant. In another example, lubricant may be provided in the pores 216 and pathways 218 by an additive manufacturing process. In another embodiment, the lubricant may be provided to the bearing race 114 in a continuous manner. For example, the bearing race 114 may be fluidly connected to a source (not shown) configured to store the lubricant. The stored lubricant may be continuously supplied from the source to the load bearing zone 112 of the bearing race 114 with the help of a conduit (not shown).

Further, in embodiments of this disclosure, the pores 216 are configured to dispense the lubricant based on a capillary action of the lubricant with the body 220 of the bearing race 114. Each pore 216 may have a diameter in the range of 0.01 micron to 500 microns. In one example, a diameter of each pore 216 may be about 0.2 microns. In another example, a diameter of each pore 216 may be about 20 microns. In yet another example, a diameter of each pore 216 may be about 250 microns. However, it may be noted that a diameter of each pore 216 may vary from one application to another depending on specific requirements of an application. A selection of the diameter for each pore 216 may be made taking into account factors including, but not limited to, a viscosity of the lubricant, an amount of lubricant to be dispensed onto the load bearing zone 112 in unit time (i.e., flow rate), etc.

Referring to FIG. 3, a cutaway section 204 of a bearing race 114 is depicted in accordance with another embodiment of this disclosure. As shown, the body 220 of the bearing race 114 includes a non-porous portion 222 remote from the porous surface 212. The non-porous portion 222 disclosed herein may form part of an outer surface of a race e.g., a sidewall 116 of the outer bearing race 104 or a sidewall 118 of the inner bearing race 102 as shown in FIG. 1. Therefore, it may be noted that in embodiments of this disclosure, the bearing race 114 may essentially include pores 216 only on the porous surface 212, and may or may not include pores 216 in other surfaces such as e.g., the sidewalls 118, 116 or outer surfaces 126, 120 of the inner bearing race 102 or the outer bearing race 104 respectively.

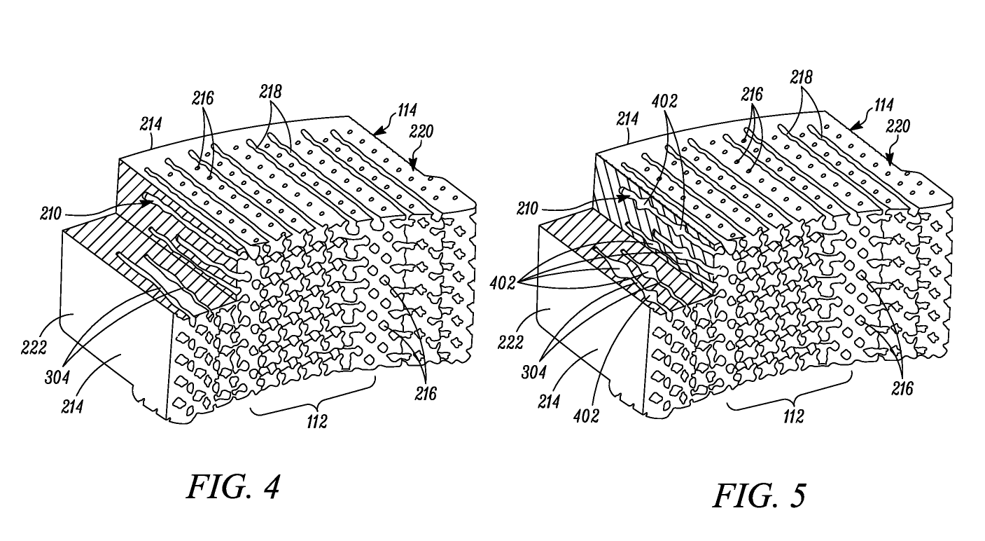

Referring now to FIGS. 4-8, illustrated are cutaway perspective views of the bearing race 114, in accordance with various embodiments of the present disclosure. In an embodiment as shown in FIG. 4, a plurality of pathways 304 extend from the pores 216 on the porous surface 212 and terminate within the porous volume 210 of the body 220. For example, if the bearing race 114 is embodied as the outer bearing race 104, the pathways 304 may be configured to extend from the pores 216 on the porous surface 212 i.e., the inner surface 122 of the outer bearing race 104 and terminate prior to an outer surface 120 of the outer bearing race 104 (refer to FIG. 1). In another example, if the bearing race 114 is embodied as the inner bearing race 102, the pathways 304 may be configured to extend from the pores 216 on the porous surface 212 i.e., the inner surface 124 of the inner bearing race 102 and terminate prior to an outer surface 126 of the inner bearing race 102 (refer to FIG. 1). As shown in FIG. 4, each pathway 304 is not in fluid communication with other pathways 304.

In another embodiment as shown in FIG. 5, at least one reservoir 402 may be formed in the porous volume 210 of the body 220. Each reservoir 402 may be configured i.e., sized and shaped so as to store a predetermined amount of lubricant therein. In an example, a geometry of each pathway 304 may be configured to have a polyhedral, ellipsoid or ovoid shape, or any other shape. As shown in FIG. 5, each pathway 304 may be in fluid communication with at least one reservoir 402.

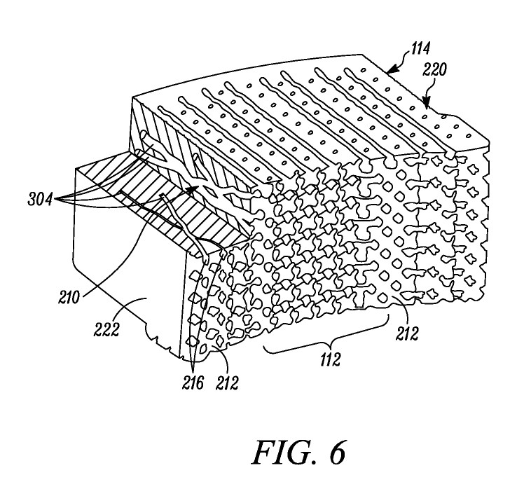

In the illustrated embodiment of FIG. 6, each of the pathways 304 is interconnected with an adjacent pathway 304 to form an interconnected network of pathways 304. However, it is to be noted that the pathways 304 in a given bearing race 114 i.e., the inner bearing race 102, the outer bearing race 104, and/or the bearing cage 106 may be configured to represent stand-alone pathways or interconnected pathways depending on specific requirements associated with the given bearing race 114, for example, depending on an amount of lubricant to be dispensed to the load bearing zone 112 associated with the given bearing race 114. In fact, it can also be contemplated by one skilled in the art to configure some of the pathways 304 in the bearing race 114 as stand-alone pathways while the remaining pathways 304 from the same bearing race 114 may be interconnected with one another to represent an interconnected matrix of pathways. Therefore, various configurations of the pathways 304 may be implemented by persons skilled in the art without deviating from the spirit of the present disclosure.

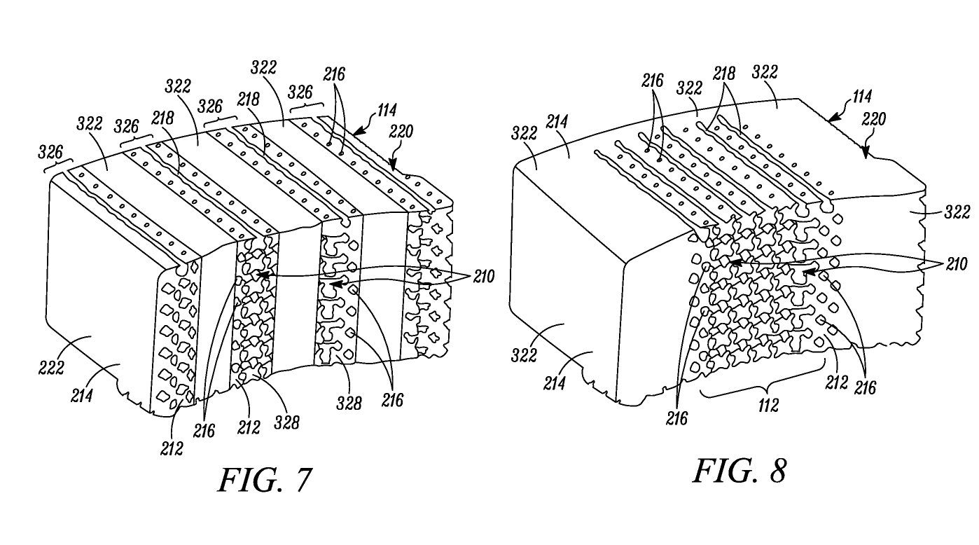

In an embodiment as shown in FIG. 7, the body 220 of the bearing race 114 includes a plurality of non-permeable portions 322 therein. The non-permeable portions 322 may divide the porous volume 210 into a plurality of porous sections 326. Each of these porous volumes 326 may contain one or more pores 216 therein. Advantageously, each of these porous sections 326 has a corresponding porous surface portion 212 as shown. This arrangement may allow for e.g., the outer bearing race 104 or the inner bearing race 102 to provide lubrication within a specific area e.g., two or more spaced apart load bearing zones 328 of the bearing race 114 as shown in FIG. 7.

Alternatively, in another embodiment as shown in FIG. 8, a contiguous non-permeable wall 322 may be defined in the body 220 of the bearing race 114. Such contiguous permeable wall 322 may be configured, for example, to prevent flow of the lubricant past the porous volume 210 of the bearing race 114.

In one example, if the bearing race 114 of FIG. 8 is embodied as the outer bearing race 104 of the bearing 100 shown in FIG. 1, the contiguous non-permeable wall 322 may be located adjacent the sidewalls 116 and the outer surface 120 of the outer bearing race 104. This prevents lubricant from escaping from the sidewalls 116 and the outer surface 120 of the outer bearing race 104 while the pores 216 on the porous surface 212 of the bearing race 114 i.e., the outer bearing race 104 continue to deliver the lubricant to the load bearing zone 112 of the outer bearing race 104.

In another example, if the bearing race 114 of FIG. 8 is embodied as the inner bearing race 102 of the bearing 100 shown in FIG. 1, the contiguous non-permeable wall 322 may be located adjacent the sidewalls 118 and the outer surface 126 of the inner bearing race 102. This prevents lubricant from escaping from the sidewalls 118 and the outer surface 126 of the inner bearing race 102 while the pores 216 on the porous surface 212 of the bearing race 114 i.e., the inner bearing race 102 continue to deliver the lubricant to the load bearing zone 112 of the inner bearing race 102.

Various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood that although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

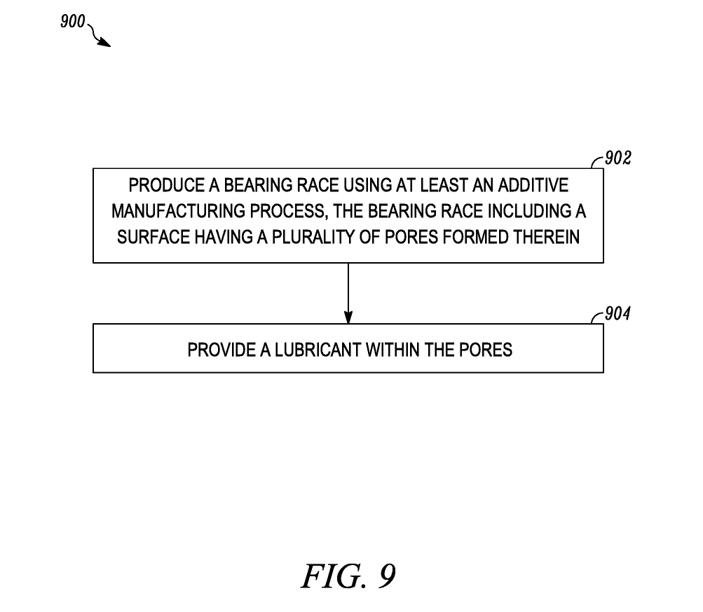

FIG. 9 illustrates a method 900 for manufacturing a bearing race, in accordance with an embodiment of the present disclosure. The method 900 is hereinafter explained in conjunction with FIGS. 1-3.

At step 902, the method 900 includes producing the bearing race 114 using at least an additive manufacturing process in which the bearing race 114 is configured to have plurality of pores formed in a surface thereof. In embodiments of this disclosure, the bearing race 114 is beneficially produced from use of an additive manufacturing process in which material is deposited in a layer-by-layer manner, but essentially the individual layers are successively deposited such that the bearing race 114 is rendered contiguous. Moreover, in the additive manufacturing process, similar or dissimilar materials may be used. When dissimilar materials are being used to form the bearing race 114, ratios by weight or volume between the dissimilar materials may be advantageously varied from one layer to another depending on specific requirements of an application including, but not limited to, weight, density, porosity, and the like.

At step 904, a lubricant is provided within the pores 216 formed in the body 220 of the bearing race 114. In an embodiment, the method 900 also includes forming at least one reservoir 402 in the body 220 and providing lubricant therein. Where a suitable lubricant is available, the lubricant may be provided by an additive manufacturing process.

The steps 902 to 904 are only illustrative and other alternatives can also be provided where one or more steps are added, one or more steps are removed, or one or more steps are provided in a different sequence without departing from the scope of the claims herein.

Embodiments of the present disclosure have applicability for use in lubricating the rolling elements and the bearing races of a bearing so that a service life of the bearing may be prolonged.

With implementation of embodiments disclosed herein, frequent maintenance such as that typically required for previously known bearing designs may be reduced. As the bearing elements of the present disclosure are made porous, lubricant may be provided to the load bearing zone through the pores. A sizing of the pores and the pathways helps to perform both a retention of the lubricant within the porous volume, and a dispensing of the lubricant onto the rolling elements at a required flow rate. Advantageously, as the bearing races are configured to store and dispense lubricant onto the rolling elements, a service life of the bearing may be prolonged.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

1. A bearing race comprising:
a surface having a plurality of pores formed therein, the pores configured to have lubricant provided in the pores; and
a body having a porous volume contiguous with the surface, wherein the porous volume comprises a plurality of pathways in fluid communication with the pores, wherein each pathway is in fluid communication with a corresponding pore, each pathway not being in fluid communication with other pathways.

2. The bearing race of claim 1, wherein the surface includes a load bearing zone, the pores being distributed on the surface to provide the lubricant to the load bearing zone.

3. The bearing race of claim 1, wherein each pore has a diameter in the range of 0.01 micron to 500 microns.

4. (canceled)

5. The bearing race of claim 1, wherein the porous volume comprises substantially all of the body.

6. The bearing race of claim 1, wherein the body includes a non-porous portion.

7. The bearing race of claim 6, wherein the non-porous portion forms an outer surface of the race remote from the porous surface.

8.-10. (canceled)

11. The bearing race of claim 1, wherein the body further comprises at least one reservoir, each reservoir in fluid communication with at least one pathway.

12.-17. (canceled)

18. A bearing comprising:
an inner bearing race;
an outer bearing race; and
a plurality of rolling elements rotatably supported between the inner and outer bearing races,
wherein at least one of the inner and outer bearing races comprises:
a surface having a plurality of pores formed therein, and
a body having a porous volume contiguous with the surface, and a plurality of non-permeable walls, wherein the non-permeable walls divide the porous volume into a plurality of sections.

19. The bearing of claim 18, wherein the porous volume comprises a plurality of pathways in fluid communication with the pores.

20. The bearing of claim 19, wherein the pathways form an interconnected network within the body.

21. The bearing of claim 19, wherein the body further comprises at least one reservoir, each reservoir in fluid communication with at least one pathway.
